(19) United States
(12) Patent Application Publication
(10) Pub. No.: US 2004/0039560 A1
(43) Pub. Date: Feb. 26, 2004

(54) Method computer program product and computer system for maintenance

(76) Inventor: Horst Hofmann, Bubenreuth (DE)

Correspondence Address: HARNESS, DICKEY & PIERCE, P.L.C., P.O.BOX 8910, RESTON, VA, 20195, US

(21) Appl. No.: 10/416,309

(22) PCT Filed: Nov. 2, 2001
(86) PCT No.: PCT/EP01/12725

(30) Foreign Application Priority Data
Nov. 9, 2000 (EP) 00124548.9

(51) Int. Cl. G06F 9/45

(52) U.S. Cl. 703/22

(57) ABSTRACT

The maintenance of a technical installation may be effected in an optimized manner with regard to time and costs. To this end, a method, a computer program product and a computer system are provided for maintenance, by way of which wear behavior of installation components may be predicted and a maintenance time and/or a maintenance action may be determined from this prediction.

This application is the national phase under 35 U.S.C. § 371 of PCT International Application No. PCT/EP01/12725 which has an International filing date of Nov. 2, 2001, which designated the United States of America and which claims priority on European Patent Application number EP 00124548.9 filed Nov. 9, 2000 the entire contents of which are hereby incorporated herein by reference.

### FIELD OF THE INVENTION

The present invention generally relates to a method, a computer program product and a computer system for maintenance of a technical facility that includes two or more system components.

### BACKGROUND OF THE INVENTION

Technical systems are being introduced in various fields of industry which are used, for example, for producing a specific product, for further processing or for refinement of raw materials, for carrying out what were formerly manual activities in an automated manner, or, in particular, for producing electrical power.

Technical facilities such as these generally have two or more system components which carry out the individual functions of the technical facility. Many of these system components are subject to mechanical wear during their operating life. During the life of the technical facility, the wear to its system components represents a major problem, since the operation of the technical facility, or at least of some of its functions, is no longer ensured when a wear limit is exceeded.

If the system component which is adversely affected by wear is not replaced in good time, then its excessive wear in general leads to at least a partial failure of the technical facility, and hence to undesirable downtimes, which can in turn lead to production failures, loss of profit and, in some circumstances, to very costly repairs to the technical facility.

In order to avoid failures caused by wear, it is known for servicing procedures to be carried out on specific system components, as soon as these have reached a specific operating life, that is to say, for example, when a motor has been run for 10 000 operating hours, a valve has carried out 5 000 switching operations, for example, or a car has been driven, for example, for 15 000 km. In this case, a so-called preventative maintenance is carried out by statistical evaluation, without taking into account actual loads on the basis of experience.

This procedure, which is known from the prior art, has the disadvantage that components are in this case often serviced or replaced which would in fact be suitable by virtue of their actual condition for ensuring their continued operation at least for a certain period of time. Such servicing, which is often superfluous, thus leads to high financial penalties, in order to ensure safe and reliable operation of the system components.

It is also known for system components to be serviced or to be replaced when they indicate conspicuous features in their operating behavior.

In order to identify conspicuous features, sensors are installed on the system components or in their vicinity, and are connected to monitoring devices. These produce monitoring signals, which can then in general be interpreted by servicing personnel for a technical facility. This interpretation is then used to draw an appropriate conclusion with regard to the servicing measures that are supposed to be necessary. This procedure can lead to servicing measures being initiated too late, since the monitoring is often carried out only on the basis of secondary measured values, and the primary cause of damage is thus identified too late, if at all. One typical example of this is cavitation damage in a pump, which cannot be measured as a primary factor and can be identified only on the basis of secondary measured values, for example the medium pressure, the medium temperature or the medium flow rate.

Furthermore, monitoring devices which are based on classical, analog measurement methods relating to pressure, temperature, rotation speed, flow rate, etc. do not make use of the entire range of information, for example that contained in the noise on the signals and power flows. It thus fails to make use of a wide range of information for monitoring and diagnosis of the behavior of components.

The major disadvantage of servicing measures that are initiated too late is that they necessarily lead to a system shutdown.

The initiation of servicing measures on the basis of sensor data can also lead to servicing procedures being initiated unnecessarily, since the monitoring on the basis of the previously mentioned secondary measured values does not reflect the actual wear or damage pattern, but only its symptoms, which need not necessarily correspond to one another.

Servicing procedures which are initiated unnecessarily lead to work on and/or replacement of system components which are intrinsically still serviceable, and thus to unnecessary ongoing financial costs.

### SUMMARY OF THE INVENTION

The present invention is based on an object of providing a method, a computer program product and a computer system for maintenance of a technical facility which includes two or more system components, to substantially guarantee timely and cost-effective servicing of the technical facility.

With regard to a method according to an embodiment of the present invention, an object is achieved by a method for maintenance of a technical facility which includes two or more system components, having the following steps:

1. The wear behavior of at least one system component is simulated.

2. The wear behavior is associated with at least one wear parameter.

3. The future development of the value of the at least one wear parameter is predicted.

4. The predicted future development of the value of the at least one wear parameter is used to derive at least one servicing time and/or at least one servicing action for the relevant system component.

The advantage of a method according to the present invention is, in particular, that the servicing time and/or the servicing action are/is related to the wear that has actually occurred. The prediction of the wear behavior makes it possible to define the servicing time and/or the servicing action specifically, when the wear to one or more system components has exceeded a permissible tolerance threshold. This prevents servicing from being initiated too early or too late, that is to say prevents unnecessary costs from being incurred for unnecessary servicing measures, while preventing maintenance operations from being carried out to an excessive, unnecessary extent.

In one advantageous refinement of the present invention, the current process data which is stored in at least one databank and/or archived long-term stored process data are/is used to simulate the wear behavior.

This makes the simulation of the wear behavior more accurate since, firstly, this results in the simulation including wear-relevant process data based on the actual current situation. Secondly, possible future loads which will govern the wear behavior can be anticipated better since the archived values of process data stored over a long time includes process data governing the wear behavior that has actually taken place in the past. If, for example, the archived long-term stored process data is now found to contain previous process data which matches the current process data well, for example in terms of the operating situation existing at that time, then there is a high probability that the current process data will in the future behave in a similar way to the identified, archived long-term stored process data. This archived long-term stored process data can then be included in the simulation, thus considerably improving the prediction of the wear behavior.

The servicing time and/or the servicing action is advantageously derived with the aid of a diagnosis system. The diagnosis system is in this case a specialized system which, based on current values of input data—such as the predicted future development of the value of a wear parameter—draws a conclusion relating to the presence of a specific current or future wear situation, and uses this, if appropriate, to derive measures, such as the production of a warning signal, the production of a defect signal or else the determination of a servicing time as the latest time at which the system or system component must be serviced. The identification of a current or future wear situation by the diagnosis system can also at the same time be linked to corresponding action proposals.

As in the case of commercially available diagnosis systems, the diagnosis system according to the present invention advantageously records and links expert knowledge relating to the technical system, frequently with the assistance of fuzzy logic and “self-learning” neural network methods.

The present invention also leads to a computer program product which can be loaded directly into the internal memory of a digital computer and includes software code sections by way of which steps of the present invention are carried out when the program is running on a computer.

The present invention leads to a computer system for maintenance of a technical facility which includes two or more system components, with the computer system including a simulation system for simulation of the wear behavior of at least one system component and being suitable for predicting the future development of the value of at least one wear parameter which is associated with the wear behavior, and for using this to derive at least one servicing time and/or at least one servicing action.

In one embodiment of the present invention, this computer system inludes a databank, in which current process data and/or archived long-term stored process data are/is stored.

Moreover, according to an embodiment of the present invention, process data such as this can be included in the simulation and prediction, in order to improve their reliability.

In an embodiment of the present invention, the computer system includes a diagnosis system which can be used to derive the servicing time and/or the servicing action.

Known diagnosis systems which, for example, use fuzzy logic methods, are particularly suitable for acquiring expert knowledge relating to the behavior of the technical facility in widely differing operating situations. The simulation and prediction data in the simulation system can then be included as input data in the diagnosis system, which uses this data and the acquired expert knowledge to derive a servicing time and/or a servicing action.

The computer system advantageously includes a training system which can be used to test simulations and to conceive new simulation tasks.

The training system is used for working interactively with the simulation system and, for example, for developing, modifying, validating and verifying self-learning mechanisms. The training system is thus a test platform, by way of which the simulations, predictions, etc., can be tested before being used for actual operation of the technical facility. Furthermore, the training system can be used to train operators, in order to make them familiar with the maintenance system. Since the training system is decoupled from the actual technical process, the functions of the computer system for maintenance can be tested and learned without this being associated with any intervention, which in some circumstances may be dangerous, in the operation of the technical facility.

The computer system advantageously also includes an engineering system, which can be used to handle the entire computer system.

The engineering system ensures the technological, engineering handling of the computer system, preferably at a graphics level. This includes, for example, the installation of the overall system, the incorporation of the technological objective, the incorporation of data and parameters, the definition of the displays and communications via the man-machine interface, any link to a process control system and, if appropriate, linking to internal and external networks as well as other electronic data processing systems.

The computer system furthermore advantageously includes a multimedia system, which is used to support the process of carrying out servicing tasks.

In the case of servicing procedures or additional diagnosis measures, the user is provided with multimedia functions, such as video and audio information, at the location of the activity via appropriate output devices, such as a screen, laptop, headset, loudspeaker, etc., to assist and follow the work. The system can also be designed to be interactive and, for example, to store procedures in order to make these available later once again in comparable situations.

Further scope of applicability of the present invention will become apparent from the detailed description given hereinafter. However, it should be understood that the detailed description and specific examples, while indicating exemplary embodiments of the present invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 illustrates a technical facility which is connected to a computer system for maintenance, and

FIG. 2 illustrates an outline sketch of a computer system for maintenance.

### DETAILED DESCRIPTION OF THE PREFERRED EMBODIMENTS

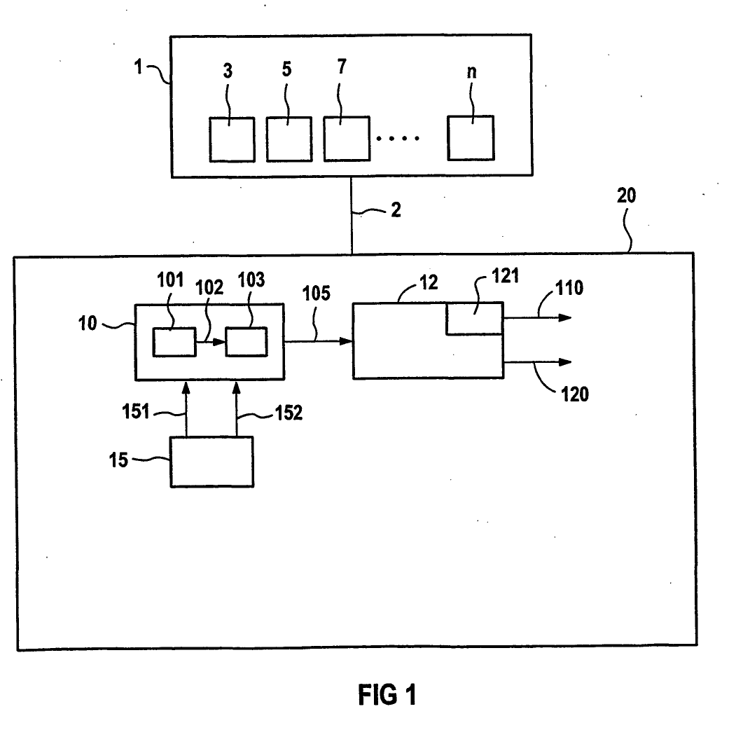

FIG. 1 shows a technical facility 1 which includes two or more system components 3, 5, 7, . . . , n. The technical facility 1 is connected via a data link 2 to a computer system 20 for maintenance. The wear behavior of the system components 3, 5, 7, . . . , n is simulated in a simulation module 101 of a simulation system 10 of the computer system 20, and this wear behavior is associated with at least one wear parameter 102. To simulate the wear behavior, the simulation system 10 makes use of current process data 151 and archived long-term stored process data 152 stored in a databank 15.

Data 105 to predict the future development of the wear parameter 102 is determined in a prediction module 103.

This data 105 relating to the predicted profile of the wear parameter 102 is passed to a downstream diagnosis system 12. The diagnosis system 12 contains an expert knowledge base 121, in which knowledge from experience of operation of the technical facility is acquired and linked, for example with the aid of fuzzy logic methods.

The diagnosis system 12 uses the predicted development of the wear parameter 102 to determine a servicing time 110 and/or a servicing action 120, for the relevant system components.

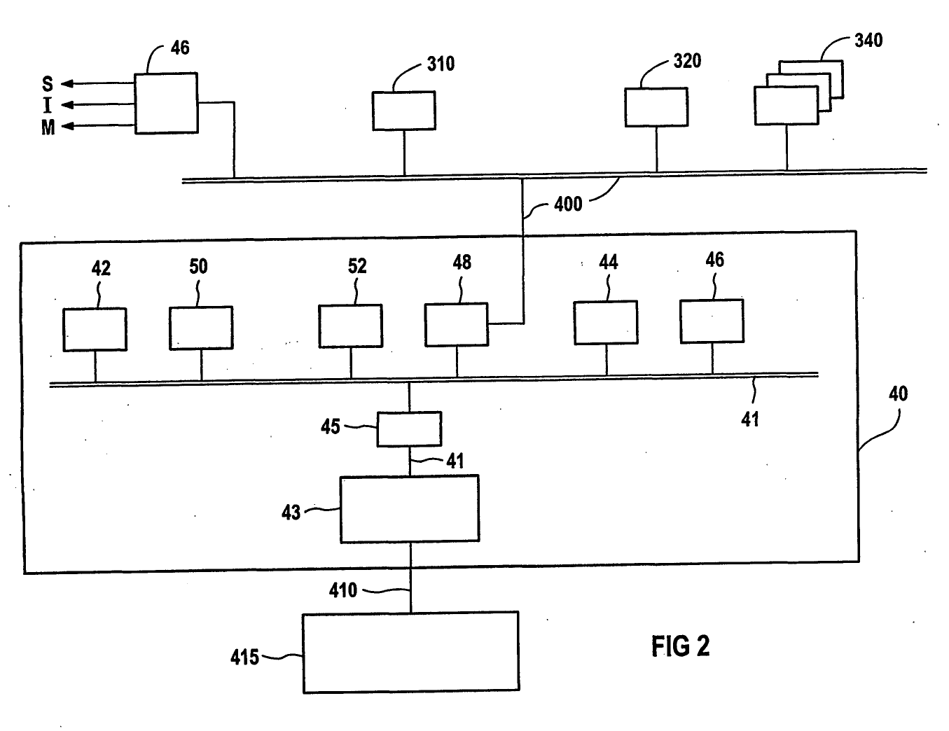

FIG. 2 shows a computer system 40 for maintenance, comprising a number of component elements. The component elements of the computer system 40 are linked to one another via a communications link 41.

Servicing-relevant aspects relating to all the components and systems in the technical facility are simulated in a simulation system 50. To do this, the simulation system 50 receives current and archived process data from a databank 45. In order to obtain this data from the processes in the technical facility, the databank 45 is linked via a gateway 43 by way of a communications link 410 to the process control system 415 of the technical facility. Since the simulation system 50 has access to the current and archived process data stored in the databank 45, the prediction of the wear behavior as determined by the simulation system 50 is very reliable, since the simulation system can match its simulation results to the actual current or stored process data.

If classical simulation methods, for example the modeling of the wear behavior with the aid of mathematical equations, are used in the simulation system 50, the validity of the simulation results is very high from the start. However, it is also possible to use more modern simulation methods, such as neural fuzzy technology with corresponding self-learning mechanisms. These more modern methods are particularly appropriate when the wear behavior cannot be mathematically recorded exactly. The validity reliability of such methods then increases only over the course of time, as the number of learning circles carried out increases.

The simulation results from the simulation system 50 are evaluated in the diagnosis system 52 and are processed to produce information, decision bases and action statements.

The diagnosis system 52 is also linked to a man-machine interface 48. The man-machine interface 48 is connected via a communications link 400 to units—for example a screen unit 310, a printer 320 or communications devices 340—which can be used by the operator to control the computer system 40. Furthermore, the computer system 40 can also communicate with remote electronic data processing systems via satellites S, the Internet I or mobile radio M, by way of a gateway 46 which is likewise connected to the communications link 400.

An engineering system 44, which is connected to the communications link 41, is used mainly to set up the software for the overall structure and functions of the computer system 40, to modify it, and to adapt it to the respective technical situation and to the requirements of the technical facility. The engineering system is also used, inter alia, for servicing and for quality management of the entire computer system 40.

A multimedia system 46, which is likewise connected to the communications link 41, contains multimedia information such as video and audio information relating to the servicing measures to be carried out in the technical facility. This information may, for example, be video information which, for example, can display the servicing action on a specific facility component in the form of a film, and can thus be used to instruct the servicing personnel on the action.

Via appropriate communications links within the technical facility, this multimedia information can be transmitted as required to the respective location of the servicing measure, thus assisting the servicing personnel. The multimedia system 46 may also be interactive and, for example, store servicing measures that have been carried out in order to make them available once again later on as required, for example where a servicing measure is being carried out.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for maintenance of a technical facility (1) which comprises two or more system components (3, 5, 7, . . . n), having the following steps:
a) the wear behavior of at least one system component (3, 5, 7, . . . , n) is simulated,
b) the wear behavior is associated with at least one wear parameter (102),
c) the future development of the value of the at least one wear parameter (102) is predicted, and
d) the predicted future development of the value of the at least one wear parameter (102) is used to derive at least one servicing time (110) and/or at least one servicing action (120) for the relevant system component (3, 5, 7, . . . , n).

2. The method as claimed in claim 1, characterized in that the current process data (151) which is stored in at least one databank (15) and/or archived long-term stored process data (152) is used to simulate the wear behavior.

3. The method as claimed in one of claims 1 or 2, characterized in that the servicing time (110) and/or the servicing action (120) is derived with the aid of a diagnosis system (12).

4. A computer program product, which can be loaded directly into the internal memory of a digital computer and comprises software code sections by means of which the steps as claimed in claim 1 are carried out when the product is running on a computer.

5. A computer system for maintenance of a technical facility which comprises two or more system components (3, 5, 7, . . . , n)
characterized in that the computer system (20) comprises a simulation system (10) for simulation of the wear behavior of at least one system component (3, 5, 7, . . . , n) and is suitable for predicting the future development of the value of at least one wear parameter (102) which is associated with the wear behavior, and for using this to derive at least one servicing time (110) and/or at least one servicing action (120).

6. The computer system as claimed in claim 5, characterized by at least one databank (15) in which current process data (151) and/or archived long-term stored process data (152) are/is stored.

7. The computer system as claimed in one of claims 5 or 6,
characterized by a diagnosis system (12) which can be used to derive the servicing time (110) and/or the servicing action (120).

8. The computer system as claimed in one of claims 5 to 7,
characterized by a training system (42) which is used to test its simulations and to conceive new simulation tasks.

9. The computer system as claimed in one of claims 5 to 8,
characterized by an engineering system (44) which can be used to handle the entire computer system (40).

10. The computer system as claimed in one of claims 5 to 9,
characterized by a multimedia system (46) which can be used to assist the process of carrying out servicing tasks.
